(19) United States
(12) Patent Application Publication
(10) Pub. No.: US 2014/0043687 A1
(43) Pub. Date: Feb. 13, 2014

(54) DIFFRACTION OPTICAL ELEMENT

(71) Applicants: Akiko Murata, Osaka (JP); Yuka Okada, Hyogo (JP); Tatsutoshi Suenaga, Osaka (JP); Takamasa Ando, Osaka (JP)

(72) Inventors: Akiko Murata, Osaka (JP); Yuka Okada, Hyogo (JP); Tatsutoshi Suenaga, Osaka (JP); Takamasa Ando, Osaka (JP)

(73) Assignee: PANASONIC CORPORATION, Osaka (JP)

(21) Appl. No.: 14/113,935

(22) PCT Filed: Jun. 6, 2012
(86) PCT No.: PCT/JP2012/003690

§ 371 Date: Oct. 25, 2013

(30) Foreign Application Priority Data
Jun. 20, 2011 (JP) 2011-136455

(51) Int. Cl. G02B 5/18

(52) U.S. Cl. CPC G02B 5/1866
USPC 359/571

(57) ABSTRACT

A diffractive optical element includes: a body being composed of a first optical material and having a diffraction grating on the surface thereof; and an optical adjustment layer being composed of a second optical material and provided on the body so as to cover the diffraction grating. An envelope passing through the edge of the diffraction grating presents a curved surface, and the optical adjustment layer has a uniform thickness along the normal direction from the envelope.

### TECHNICAL FIELD

The present application relates to a diffractive optical element, and relates to a diffractive optical element composed of two or more different members.

### BACKGROUND ART

A diffractive optical element is structured so that a diffraction grating for diffracting light is provided on a body which is composed of an optical material such as a glass or a resin. Diffractive optical elements are used in the optical systems of various optical devices, including imaging devices and optical recording apparatuses. For example, lenses which are designed to gather diffracted light of a specific order to one point, spatial low-pass filters, polarizing holograms, and the like are known.

A diffractive optical element has an advantage in that it allows for a compact optical system. Moreover, conversely to refraction, a greater diffraction occurs for light of longer wavelengths. Therefore, by combining a diffractive optical element and a usual optical element which utilizes refraction, it is possible to improve the chromatic aberration and curvature of field of an optical system.

However, since diffraction efficiency theoretically depends on light wavelength, there is a problem in that, if at diffractive optical element is designed so as to attain an optimum diffraction efficiency for light of a specific wavelength, its diffraction efficiency will be lower for light of any other wavelength. For example, in the case where a diffractive optical element is employed in an optical system which utilizes white light, e.g., a lens for a camera, such wavelength dependence of diffraction efficiency will cause color unevenness and flares doe to light of unwanted orders, and thus it is difficult to construct an optical system having appropriate optical characteristics with diffractive optical elements alone.

Against such problems, Patent Document 1 discloses a phase-difference type diffractive optical element which includes a body being composed of an optical material and having a diffraction grating provided on its surface, and an optical adjustment layer being composed of an optical material different from that of the body and covering the diffraction grating.

Assume that the light which is transmitted through the diffractive optical element has a wavelength λ; refractive indices of the two types of optical materials at the wavelength λ are n1 (λ) and n2 (λ); and the diffraction grating has a depth d. When refractive indices n1 (λ) and n2 (λ) and d satisfy the relationship of eq. (1) below, the m^{th}-order diffraction efficiency with respect to light of the wavelength λ will be 100%. Herein, m is an integer indicating an order of diffraction.

$$\begin{matrix}[ Eq . 1 ] & \\ d = \frac{m λ}{\vert n 1 ( λ ) - n 2 ( λ ) \vert} & ( 1 )\end{matrix}$$

Therefore, if optical material having a refractive index n1 (λ) and an optical material having a refractive index n2 (λ) can be combined which nave wavelength dependences such that d is approximately constant in the wavelength band of the light used, it is possible to reduce the wavelength dependence of diffraction efficiency. Generally speaking, a material having a high refractive index and a low wavelength dispersion and a material having a low refractive index and a high wavelength dispersion are to be combined. Patent Document 1 discloses using a glass or a resin as an optical material composing the body and using a UV-Curing resin as an optical material composing the optical adjustment layer.

Patent Document 2 discloses, in a phase-difference type diffractive optical element having a similar structure, using a glass as an optical material composing the body and an energy-curing resin as an optical material composing the optical adjustment layer. Patent Document 2 discloses that this structure allows wavelength dependence of diffraction efficiency to be reduced, and effectively prevents occurrence of flares and the like due to color unevenness and light of unwanted orders.

### CITATION LIST

### Patent Literature

[Patent Document 1] Japanese Laid-Open Patent Publication No. 10-268116

[Patent Document 2] Japanese Laid-Open Patent Publication No. 2001-249208

### SUMMARY OF INVENTION

### Technical Problem

The inventors have studied the optical characteristics and durability of conventional phase-difference type diffractive optical elements, to find that color unevenness may occur even in diffractive optical elements which are designed so as to provide adequate optical performance, e.g., MTF (Modulation Transfer Function), when they are used for imaging. It has also been found that an optical adjustment layer may get cracks during the formation of the optical adjustment layer or an environmental test such as a thermal shock test. Furthermore, it has been found that conventional diffractive optical elements have little tolerance as to the shape of the optical adjustment layer for obtaining an optical performance as designed, and that a diffractive optical element with a desired optical performance is difficult to obtain unless the optical adjustment layer is formed with a high precision.

One non-limiting and exemplary embodiment of the present application provides a diffractive optical element having a novel structure that solves at least one of such conventional problems.

### Solution To Problem

A diffractive optical element according to an embodiment of the present invention comprises: a body being composed of a first optical material, and having a diffraction grating on a surface thereof; and an optical adjustment layer being composed of a second optical material, and provided on the body so as to cover the diffraction grating, wherein, an envelope passing through an edge of the diffraction grating presents a curved surface; and the optical adjustment layer has a uniform thickness along a normal direction from the envelope.

### Advantageous Effects Of Invention

According to an embodiment of the present invention, the optical adjustment layer has a constant thickness along the normal direction from an envelope passing through the edge of the diffraction grating, so that differences in the thickness of the optical adjustment layer that is traveled by the light beam can be decreased between the central portion and the periphery of the lens, whereby color unevenness is reduced. Furthermore, even when a lens with a large curvature is produced, the problem of reduced thickness of the optical adjustment layer at the lens periphery is eliminated, whereby crack occurrences are prevented when conducting an environmental test such as a thermal shock test. Moreover, an increased tolerance can be provided in terms of deviation in a direction perpendicular to the optical axis of the optical adjustment layer, so that a diffractive optical element having a broad manufacturing margin can be produced.

### BRIEF DESCRIPTION OF DRAWINGS

FIG. 1(a) is a diagram schematically showing a cross-sectional structure of a conventional diffractive optical element, and (b) is a diagram schematically showing the thickness distribution of the optical adjustment layer along a radial direction.

FIG. 2(a) is a diagram schematically showing a cross-sectional structure of a first embodiment of an optical element diffractive according to the present invention, and (b) is a diagram schematically showing the thickness distribution of the optical adjustment layer along a radial direction.

FIG. 3(a) to (c) are step-by-step cross-sectional views showing an exemplary production method for the diffractive optical element shown in FIG. 2.

FIG. 4(a) is a diagram schematically showing a cross-sectional structure of a second embodiment of an optical element diffractive according to the present invention, and (b) is a diagram schematically showing the thickness distribution of the optical adjustment layer along a radial direction.

FIG. 5 A graph for describing a definition of an effective particle size of particles.

### DESCRIPTION OF EMBODIMENTS

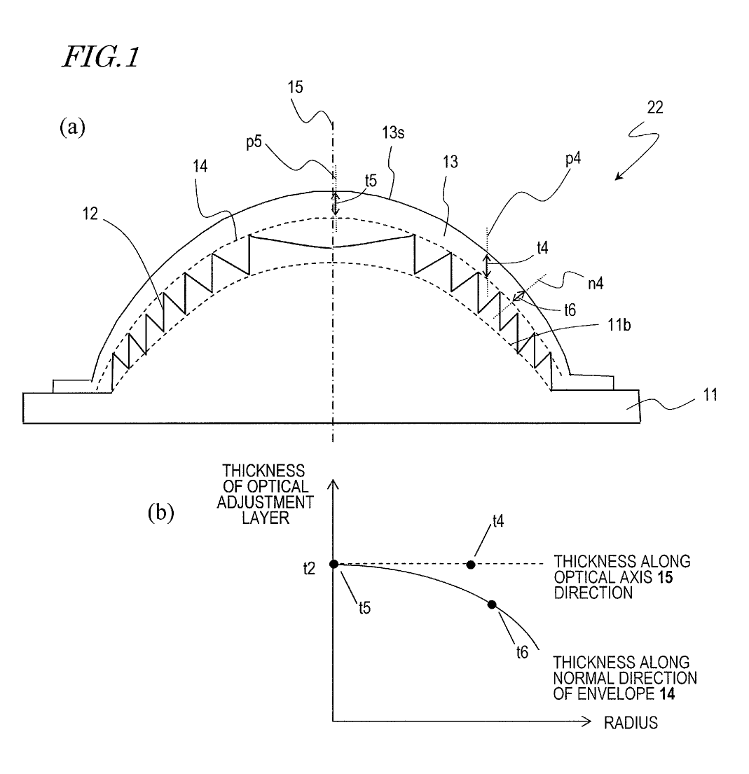

In order to solve the aforementioned problem of conventional diffractive optical element, the inventors have conducted a detailed study of the structure of conventional diffractive optical elements. FIG. 1(a) schematically shows a cross-sectional structure of a conventional diffractive optical element 22, and FIG. 1(b) shows the thickness distribution of an optical adjustment layer 13 along a radial direction.

The conventional diffractive optical element 22 includes: a body 11 being composed of a first optical material and having a diffraction grating 12 provided on its surface; and an optical adjustment layer 13 being composed of a second optical material and covering the diffraction grating 12. Generally speaking, in order to introduce a converging action of a lens in addition to the diffractive action of the diffraction grating 12, the diffraction grating 12 in the diffractive optical element 22 is provided on a body 11 which has an aspherical base shape 11b functioning as a lens. Thus, an envelope 14 passing through the edge of the diffraction grating 12 has the same aspherical shape as the base shape 11b.

Since the optical adjustment layer 13 is provided in order to reduce the wavelength dependence of the diffraction grating 12, the surface configuration of the optical adjustment layer 13 is usually set to the same aspherical shape as the edge envelope 14 of the diffraction grating 12 for design optimization. This is because, since the aforementioned function of the optical adjustment layer 13 is determined by the second optical material of the optical adjustment layer 13, there is no need to change the shape of a surface 13s of the optical adjustment layer 13; rather, by setting it to the same aspherical shape as the edge envelope 14 of the diffraction grating 12 lens, design optimization becomes possible without increasing the parameters.

However, the inventors have studied the structure and the like or the conventional diffractive optical element 22 to find that, when the surface shape of the optical adjustment layer 13 is the same aspherical shape as the edge envelope 14 of the diffraction grating 12, the following problems occur.

When the surface shape of the optical adjustment layer 13 and the edge envelope 14 of the diffraction grating 12 have the same aspherical shape, as shown in FIGS. 1(a) and (b), the optical adjustment layer 13 has the same thickness along the direction of the optical axis 15, except for the portions falling into the annular zones of the diffraction grating 12. In other words, a thickness t5 at the optical axis 15 is equal to a thickness t4 along a direction p4 which is parallel to the optical axis 15 but taken at any arbitrary point along the radius. However, in this case, light which is diffracted by the diffraction grating 12 does not always enter the optical adjustment layer 13 at an angle parallel to the optical axis. Therefore, in the case of a lens with a small radius of curvature, for example, a light beam will travel a long distance at the lens center, and an increasingly shorter distance toward the periphery. Therefore, light which is transmitted closer to the periphery of the diffractive optical element will experience a shorter optical path length. On the other hand, due to electronic transition absorption, the resin material used for the optical adjustment layer is likely to have a lowered transmittance at the short wavelength side, i.e., closer to the ultraviolet region; moreover, transmittance exponentially decreases against increase in thickness. Therefore, between the central portion and the periphery of the lens, differences in transmittance will occur, especially at the short wavelength end. As a result, when the conventional diffractive optical element 22 is used for taking an image, the image which has been taken may have color unevenness.

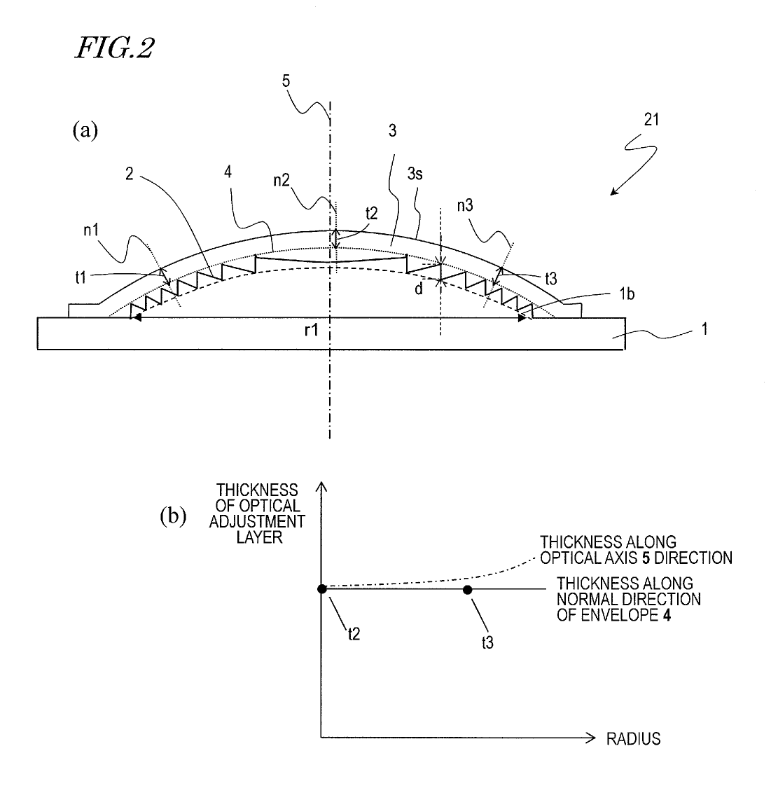

Moreover, the substantial thickness of the optical adjustment layer 13 is defined by the thickness of the optical adjustment layer 13 along the normal direction at each point on the envelope 14. As shown in FIG. 2 (a), a thickness t6 along the normal direction n4 at the periphery is smaller than the thickness t5 along the normal direction at the central portion. As shown in FIG. 2(b), the thickness along the direction of the optical axis 15 is constant at any position upon the radius, but the normal direction thickness of the envelope 14 decreases toward the periphery. Therefore, in the optical adjustment layer 13, stress differences that are thickness-dependent may occur between the central portion and the periphery, so that cracks are likely to emerge in the optical adjustment layer 13 during formation of the optical adjustment layer 13 or when conducting an environmental test such as a thermal shock test.

Moreover, as the base shape 11b of the body 11 increases in curvature, the curvature of the envelope 14 will also increase, thus reducing the normal direction thickness t6 of the envelope 14 more toward the periphery. Therefore, there is little tolerance for deviation of the center of the shape of the surface 13s of the optical adjustment layer 13 from the optical axis 15 of the body 11. In order to increase this tolerance, it might be possible to increase the thickness of the optical adjustment layer 13 along the direction of the optical axis 15; in this case, however, the aforementioned color unevenness would become conspicuous.

Based on these findings, the inventors have arrived at a diffractive optical element having a novel structure.

Embodiments of the present invention can be summarized as follows.

A diffractive optical element according to an embodiment of the present invention comprises: a body being composed of a first optical material, and having a diffraction grating on a surface thereof; and an optical adjustment layer being composed of a second optical material, and provided on the body so as to cover the diffraction grating, wherein, an envelope passing through an edge of the diffraction grating presents a curved surface; and the optical adjustment layer has a uniform thickness along a normal direction from the envelope.

A surface of the optical adjustment layer presents an aspherical shape.

The second optical material comprises a resin.

The second optical material further comprises inorganic particles, the inorganic particles being dispersed within the resin.

A refractive index of the first optical material is smaller than a refractive index of the second optical material, and a wavelength dispersion of the refractive index of the first optical material is greater than a wavelength dispersion of the refractive index of the second optical material.

The first optical material comprises another resin.

In a diffractive optical element according to an embodiment of the present invention, an optical adjustment layer is formed so as to cover a body having a diffraction grating, the optical adjustment layer having a uniform film thickness along the normal direction of an envelope passing through the edge of the diffraction grating. Thus, it is possible to reduce cracks caused by stress acting on the optical adjustment layer due to shrinkage through curing of the second optical material during production, or an environmental test such as a thermal shock test, and also reduce color unevenness.

Note that merely modifying a conventional diffractive optical element so that its optical adjustment layer has a uniform thickness along the normal direction of an envelope passing through the edge of the diffraction grating would allow the MTF characteristics of the diffractive optical element to be deteriorated. In the diffractive optical element according to the present embodiment, in order to suppress deterioration in MTF characteristics, the diffractive optical element is designed so that the distance along the normal direction between an envelope passing through the edge of a diffraction grating and the surface of an optical adjustment layer is kept constant within an effective region of the diffractive optical element, and the characteristics of the diffractive optical element are optimized based on the shapes of other faces of the body, etc., as parameters, whereby practically adequate characteristics are attained. Hereinafter, specific embodiments of the present invention will be described.

### First Embodiment

FIG. 2 (a) shows a cross-sectional view of an embodiment of a diffractive optical element according to the present invention. The diffractive optical element 21 includes a body 1 and an optical adjustment layer 3. The body 1 is composed of a first optical material, whereas the optical adjustment layer 3 is composed of a second optical material containing a second resin.

A diffraction grating 2 is provided on one principal face of the body 1. The cross-sectional shape, positioning, pitch, and depth of the diffraction grating 2 are to be determined based on the optical characteristics of the body 1 and the optical adjustment layer 3 and the optical design of the diffractive optical element 21 to be finally obtained. For example, in order to confer a lens action to the diffraction grating 2, a diffraction grating having a sawtooth cross-sectional shape may be provided in the form of concentric circles with pitches gradually changing from the lens center toward the perimeter. In this case, preferably the base shape 1b (an envelope passing through the grooves of the diffraction grating 2) of the body 1 presents an aspherical surface or a spherical surface. As a result, an optimum combination of a refractive action by the base shape of the body 1 and a diffractive action by the diffraction grating 2 can be realized, whereby the chromatic aberration, curvature of field, and the like can be improved with a good balance, and a lens having a high imaging performance can be obtained. The depth d of the diffraction grating 2 can be determined by using eq. (1).

FIG. 2(a) shows a diffractive optical element having the diffraction grating 2 on one principal face; however, a diffraction grating 2 may also be provided on the other principal face of the body 1. FIG. 2(a) shows a diffractive optical element one of whose faces is a convex surface having the diffraction grating 2 and whose opposite face is a plane; however, so long as a diffraction grating is formed on at least one face, the two principal faces of the body 1 may be both convex surfaces, a convex surface and a concave surface, or both concave surfaces. In this case, the diffraction grating(s) may be formed on only one face, or on both faces. In the case where the diffraction gratings are formed on both faces, the diffraction gratings on both faces do not need to be identical in shape, positioning, pitch, and diffraction grating depth, so long as they satisfy the performance that is required of the diffractive optical element.

Preferably, the effective region of the diffractive optical element 21, i.e., the region of the body 1 in which the diffraction grating 2 is provided, has a diameter r1 of 2.6 mm or less. Moreover, the envelope (base shape 1b) passing through the grooves of the diffraction grating 2 preferably has a radius of curvature of ±1.3 mm or less (i.e., in the range from −1.3 mm to +1.3 mm). When the diameter and radius of curvature are within these ranges, it is easy to obtain a difference between the thickness along the normal direction and the thickness along the optical axis direction from the envelope of the optical adjustment layer 3, especially at the periphery of the diffraction grating 2; as a result, the const ruction of the present invention will become effective.

For the purpose of reducing the wavelength dependence of diffraction efficiency of the diffractive optical element 21, the optical adjustment layer 3 is provided so as to cover the principal face of the body 1 on which the diffraction grating 2 is provided, in a manner of at least filling the stepped portions of the diffraction grating 2. In the present embodiment, as shown in FIG. 2(a), except for the portions falling into the annular zones of the diffraction grating 2, the optical adjustment layer 3 has uniform thicknesses t1, t2, and t3 along the normal (n1, n2, n3) directions of the envelope 4 passing through the edge of the diffraction grating 2. In other words, the thickness that is defined by the surface 3s of the optical adjustment layer 3 and the envelope 4 passing through the edge of the diffraction grating 2 is uniform along the normal (n1, n2, n3) direction of the envelope 4. As used herein, a uniform thickness means that the deviation from a design value of thickness is within a ±2% range at any arbitrary position on the optical adjustment layer 3. As a result of this, cracks are prevented from occurring in the optical adjustment layer 3 when an environmental test such as a thermal shock test is conducted, and also color unevenness in a captured image can be reduced.

FIG. 2(b) schematically shows the thickness along the normal direction of the envelope 4 and the thickness along the optical axis 5 direction in the optical adjustment layer 3. The normal direction thickness of the optical adjustment layer 3 is essentially constant, irrespective of the radial position. On the other hand, the thickness of the optical axis 5 direction increases as the radial position increases.

In order to reduce the wavelength dependence of diffraction efficiency, it is preferable that the body 1 and the optical adjustment layer 3 essentially satisfy eq. (1) across the entire wavelength region of light that is used. As used herein, “essentially satisfy” specifically means that eq. (1′) below is satisfied across the entire wavelength region of light that is used.

$$\begin{matrix}[ Eq . 2 ] & \\ 0.95 d \leq \frac{λ}{\vert n 1 ( λ ) - n 2 ( λ ) \vert} \leq 1.05 d & ( {1}^{′} )\end{matrix}$$

For this purpose, it is preferable that the first optical material of the body 1 and the second optical material of the optical adjustment layer 3 have characteristics such that they exhibit opposite tendencies in terms of wavelength dependence of the refractive index, so that changes in the refractive index with respect to wavelength are mutually canceled. More specifically, it is preferable that the refractive index of the first optical material is smaller than the refractive index of the second optical material, and that the wavelength dispersion of the refractive index of the first optical material is greater than the wavelength dispersion of the refractive index of the second optical material. Conversely, so long as eq. (1) is satisfied, the refractive index of the first optical material may be greater than the refractive index of the second optical material, and the wavelength dispersion of the refractive index of the first optical material may be smaller than the wavelength dispersion of the refractive index of the second optical material.

The wavelength dispersion of the refractive index is expressed by an Abbe number, for example. The greater the Abbe number is, the smaller the wavelength dispersion of the refractive index is. Therefore, it is preferable that the refractive index of the first optical material is smaller than the refractive index of the second optical material, and that the Abbe number of the first optical material is smaller than the Abbe number of the second optical material.

Preferably, the envelope 4 passing through the edge of the diffraction grating 2 presents a curved surface; specifically, it is preferably a spherical shape or an aspherical shape. It is especially preferable if the envelope 4 has an aspherical shape, because the lens aberration which could not be corrected for in the case of a spherical shape can now be corrected for. A face having an “aspherical shape” is a curved surface satisfying eq. (2) below.

$$\begin{matrix}[ Eq . 3 ] & \\ z = \frac{{c ( {x}^{2} - {y}^{2} )}^{2}}{1 + \sqrt{1 - ( K + 1 ) {{c}^{2} ( {x}^{2} - {y}^{2} )}^{4}}} + {A ( {x}^{2} - {y}^{2} )}^{4} + {B ( {x}^{2} - {y}^{2} )}^{6} + C ( {x}^{2} - {y}^{2} ) 8 + {D ( {x}^{2} - {y}^{2} )}^{10} & ( 2 )\end{matrix}$$

Herein, eq. (2) is an equation representing an aspherical surface when rotated around a Z axis which is perpendicular to an X-Y plane, where c is a center curvature, and A, B, C, and D are coefficients representing deviation from the quadric surface. Depending on the K value, the following aspherical surface will be obtained;

when 0>K, an ellipsoid whose minor axis is the optical axis;

when −1<K<0, an ellipsoid whose major axis is the optical axis;

when K=−1, a paraboloid; and

when K<−1, a hyperboloid.

Preferably, the first optical material composing the body 1 has sufficient transparency in the wavelength band of the light that is used or in the design wavelength band. Moreover, it preferably satisfies the relationship of eq. (1) or eq. (1′) with the second optical material. For example, an optical glass, a transparent ceramic, a transparent resin for optical use, etc., can be used as the first optical material. Among others, from the standpoint of producibility, it is preferable that the first optical material composing the body 1 contains a resin. The reason for using a resin-containing material as the first optical material is as follows. When considering molding, which is expected to provide the most producibility in lens production, a glass-containing material would result in a mold durability which is 1/10 or less of that for a resin-containing material, and production of the body 1 having a diffraction grating shape is not easy. On the other hand, a resin-containing material allows use of a production method with a high mass producibility, e.g., injection molding. Since a resin-containing material facilitates micromachining via molding or other machining techniques, by reducing the pitch of the diffraction grating 2, the performance of the diffractive optical element 21 can be improved, and the diffractive optical element 21 can be downsized. Furthermore, it is possible to reduce the weight of the diffractive optical element 21.

As the resin, from among the translucent resin materials which are generally used as bodies of optical elements, a material having refractive index characteristics and wavelength dispersion for making it possible to reduce the wavelength dependence of diffraction efficiency of the diffractive optical element at a designed order. Other than resin, the first optical material may contain inorganic particles for adjusting optical characteristics, e.g., the refractive index, and dynamic properties, e.g., thermal expansion, and additives such as a dyestuff or pigment for absorbing electromagnetic waves in a specific wavelength region.

The second optical material composing the optical adjustment layer 3 contains a second resin. The reason for using a resin-containing material as the second optical material is also for a good moldability of the optical adjustment layer 3 filling the stepped portions of the diffraction grating 2. Furthermore, a lower molding temperature than that of an inorganic material is obtained, which is particularly preferable in the case where the body 1 is composed of a first optical material containing a first resin. Furthermore, from the standpoint of producibility, the second resin is preferably an energy beam curing resin.

Note that a resin material shrinks upon curing, which causes internal stress. Since internal stress is in inverse proportion to thickness, if the cured resin has portions with different thicknesses, internal stress differences will emerge. In this case, in an environment where the resin temperature drastically changes, e.g., at curing of the resin or during a thermal shock test, stress will concentrate at thin portions of the resin, and thus cracks are likely to occur. With the diffractive optical element 21 of the present embodiment, the mechanical thickness of the optical adjustment layer 3, i.e., the thickness along the normal direction of the envelope, is uniform, whereby increase in internal stress difference at the time of resin curing or drastic temperature changes is suppressed, whereby cracks are restrained from occurring in the optical adjustment layer 3.

As mentioned earlier, in order to suppress deterioration in the MTF characteristics or the entire diffractive optical element 21 due to the optical adjustment layer 3 having a constant thickness along the normal direction, the diffractive optical element 21 is preferably designed in such a manner that parameters of the optical adjustment layer 3 other than the thickness along the normal direction of the envelope are optimized with the use of lens design software. Examples of parameters to be optimized may include parameters defining the base shape 1b of the body 1, the aspherical shape of the principal face on which the diffraction grating of the body 1 is not provided, and so on.

The diffractive optical element 21 can be produced by the following method, for example. As the method of production, molding, cutting, grinding, optical forming, or the like can be used. Especially in the case where the second optical material contains resin, the diffractive optical element 21 can be produced with a nigh producibility by performing injection molding.

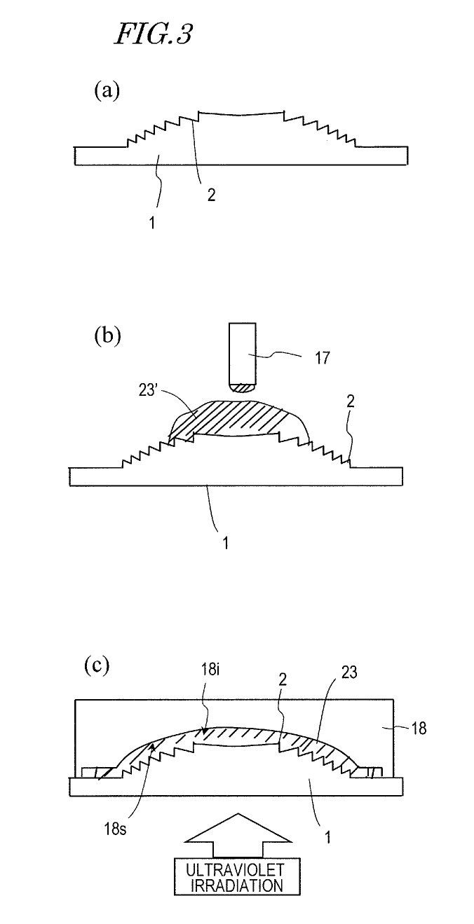

First, as shown in FIG. 3(a), by using the first optical material composing the body 1, the body 1 having the diffraction grating 2 provided thereon is produced. As described above, producibility is enhanced by producing the body 1 through injection molding.

Next, as shown in FIG. 3(b), by using a dispenser 17 or the like, a raw material 23′ of the second optical material is placed on the diffraction grating 2 of the body 1. Thereafter, as shown in FIG. 3(c), a mold 18 is pressed against the raw material 23′ of the second optical material from above the raw material 23′ of the second optical material, whereby it is molded into the shape of the optical adjustment layer 3. The surface 18s of the mold 18 has a shape corresponding to the surface 3s of the optical adjustment layer 3, and a space 18i interposed between the surface 18s of the mold 18 and the body 1 defines the shape of the optical adjustment layer 23.

In the case where the second optical material contains a UV-curing resin, the second optical material is cured by being irradiated with ultraviolet from the rear face of the body 1, or, in the case where a light-transmitting mold 18 is used, through the mold. By separating the body 1 having the cured optical adjustment layer 23 provided thereon from the mold, the diffractive optical element 21 is obtained.

Alignment between the mold 18 and the body 1 along a direction which is perpendicular to the optical axis depends on the structure of the mold, the surface 3s of the optical adjustment layer 3 (curvature of the curved surface), and the optical characteristics required of the diffractive optical element. In the case where the diameter of the diffractive optical element is about 1 to 2 mm, precision of this alignment is preferably 10 μm or less.

Thus, with the diffractive optical element of the present embodiment, the optical adjustment layer has a uniform thickness along the normal direction of the envelope through the edge of the diffraction grating, so that cracks will not occur in an environmental test such as a thermal shock test, and a diffractive optical element which allows little color unevenness in a captured image can be obtained. Furthermore, a large tolerance for deviation in a direction which is perpendicular to the optical axis of the optical adjustment layer can be obtained, whereby a diffractive optical element with a broad manufacturing margin can be provided.

### Second Embodiment

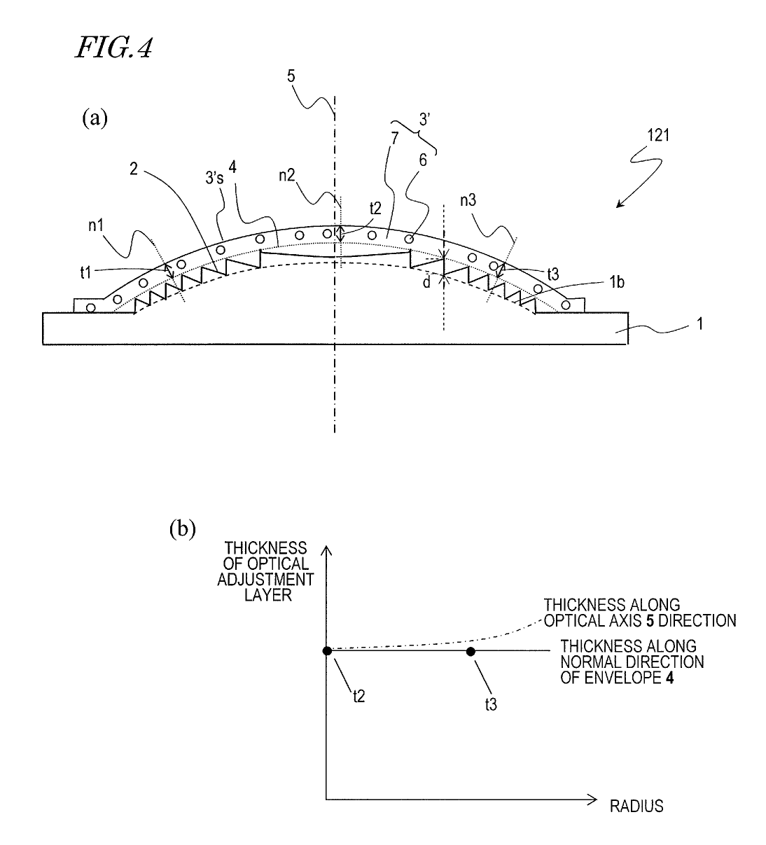

A second embodiment of the diffractive optical element according to the present invention will be described. FIG. 4 schematically shows a cross section of a diffractive optical element 121. The diffractive optical element 121 differs from the first embodiment in that a composite material obtained by dispersing inorganic particles 6 in a second resin 7 is used as a second optical material composing the optical adjustment layer 3′. The Applicants have proposed in International Publication No. 07/026597 a diffractive optical element in which such a composite material is used for the optical adjustment layer.

Since a composite material obtained by dispersing the inorganic particles 6 in the second resin 7 is used, it becomes possible to adjust the refractive index and the Abbe number of the second optical material. Therefore, by using the second optical material having the adjusted appropriate refractive index and Abbe number as the optical adjustment layer 3′, the diffraction efficiency in the wavelength band of the diffractive optical element 121 can be improved.

Moreover, by dispersing the inorganic particles 6 having a high refractive index in the second resin 7, it becomes possible for the second optical material to have a high refractive index that cannot be attained with only a resin. Therefore, the refractive index difference between the first optical material and the second optical material can be broadened, which makes it possible to reduce the depth of the diffraction grating 2, as is clear from eq. (1) and eq. (1′). As a result, in the case where the body 1 is produced by molding, the diffraction grating 2 will have an improved transferability. Moreover, since the stepped portions of the diffraction grating 2 can be made shallow, transfer is still easy even when the intervals between the stepped portions are narrowed. This allows for an improvement in diffraction performance based on a narrower pitch of the diffraction grating 2. Furthermore, it becomes possible to use a material having various physical characteristics for the second resin, and reconciliation with characteristics other than optics is more facilitated.

Generally speaking, the inorganic particles 6 are likely to have a higher refractive index than those of resins. Therefore, in the case where a first optical material containing a first resin is used for the body 1 and a second optical material obtained by dispersing the inorganic particles 6 in the second resin 7 is used as the optical adjustment layer 3′, it is preferable that the second optical material is adjusted so as to exhibit a higher refractive index and a lower wavelength dispersion than those of the first optical material, because then there will be more materials to choose from as the inorganic particles 6, In other words, it is preferable that the first optical material has a lower refractive index and a higher wavelength dispersion than those of the second optical material.

The refractive index of the second optical material as the composite material can be inferred based on the Maxwell-Garnett theory expressed by eq. (3) below, from the refractive indices of the second resin 7 and the inorganic particles 6, for example.

In eq. (3), n_{COM}λ is an average refractive index of the second optical material at a given specific wavelength λ, whereas nₚλ and nₘλ are the refractive indices of the inorganic particles and second resin at this wavelength λ. P is a volumetric ratio of the inorganic particles relative to the entire second optical material. In eq. (2), by inferring the refractive indices at Fraunhofer's D line (589.2 nm), F line (486.1 nm), and C line (656.3 nm) as the wavelengths λ, it is possible to further infer the Abbe number of the composite material. Conversely, the mixing ratio between the second resin and the inorganic particles may be determined through an inference based on this theory.

$$\begin{matrix}[ Eq . 4 ] & \\ {n}_{COM λ}^{2} = \frac{{n}_{p λ}^{2} + 2 {n}_{m λ}^{2} + 2 P ( {n}_{p λ}^{2} + 2 {n}_{m λ}^{2} )}{{n}_{p λ}^{2} + 2 {n}_{m λ}^{2} - P ( {n}_{p λ}^{2} + 2 {n}_{m λ}^{2} )} {n}_{m λ}^{2} & ( 3 )\end{matrix}$$

Note that, in the case where the inorganic particles 6 absorb light or the inorganic particles 6 include a metal in eq. (3), the retractive index of eq. (3) is to be calculated as a complex refractive index. Eq. (3) is an equation which holds true when nₚλ≧nₘλ. When nₚλ<nₘλ, the refractive index is to be inferred by using eq. (4) below.

$$\begin{matrix}[ Eq . 5 ] & \\ {n}_{COM λ}^{2} = \frac{{n}_{m λ}^{2} + 2 {n}_{p λ}^{2} + 2 ( 1 - P ) ( {n}_{m λ}^{2} + 2 {n}_{p λ}^{2} )}{{n}_{m λ}^{2} + 2 {n}_{p λ}^{2} - ( 1 - P ) ( {n}_{m λ}^{2} + 2 {n}_{p λ}^{2} )} {n}_{p λ}^{2} & ( 4 )\end{matrix}$$

As described above, in the case where a second optical material made of a composite material is used for the optical adjustment layer 3′, it is necessary that the second optical material has a higher refractive index than that of the first optical material and a lower wavelength dispersion than that of the first optical material. Therefore, it is preferable that the main component of the inorganic particles 6 to be dispersed in the second resin is also a material having a low wavelength dispersion, i.e., a high Abbe number. It is particularly preferable that the main component is at least one oxide selected from the group consisting of zirconium oxide (Abbe number: 35), yttrium oxide (Abbe number; 34), lanthanum oxide (Abbe number; 35), hafnium oxide (Abbe number 32), scandium oxide (Abbe number: 27), alumina (Abbe number; 76), and silica (Abbe number; 68), for example. Alternatively, a complex oxide thereof may be used. So long as eq. (1) or eq. (1′) is satisfied in the light wavelength band in which the diffractive optical element 121 is used, inorganic particles exhibiting a high refractive index, such as titanium oxide and zinc oxide, may be allowed to coexist with these inorganic particles.

It is preferable that the effective particle size of the inorganic particles 6 is no less than 1 nm and no more than 100 nm. When the effective particle size is 100 nm or less, losses due to Rayleigh scattering can be reduced, and the transparency of the optical adjustment layer 3′ can be enhanced. When the effective particle size is 1 nm or more, influences of light emission due to a quantum effect and the like can be suppressed. As necessary, the second optical material may contain additives such as a dispersant for improving the dispersiveness of the inorganic particles, a polymerization initiator, and a leveling agent.

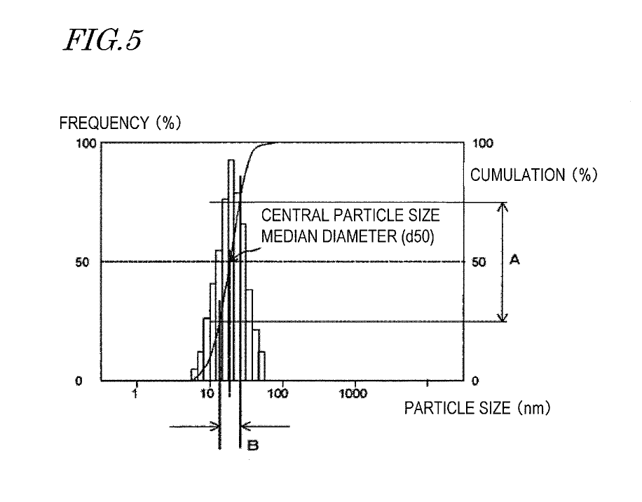

Now, the effective particle size will be described with reference to FIG. 5. In FIG. 5, the horizontal axis represents particle size of inorganic particles, whereas the left vertical axis represents frequency of inorganic particles with respect to the particle size on the horizontal axis. The right vertical axis represents cumulative frequency of particle sizes. An effective particle size refers to, in a particle size frequency distribution of the entirety of inorganic particles, a range B of particle sizes whose cumulative frequency falls within a range A of 50% around a central particle size, the central particle size being defined as a particle size whose cumulative frequency is 50% (median diameter: d50). Therefore, it is preferable that the range of the effective particle size of the inorganic particles 6 thus defined is in the range of no less than 1 nm and no more than 100 nm. In order to accurately determine an effective particle size value, it is preferable to measure 200 or more inorganic particles, for example.

In the case where a second optical material made of a composite material is used for the optical adjustment layer 3′, the stepped portions of the diffraction grating 2 can be made shallow, and the optical adjustment layer 3′ to be formed so as to cover the diffraction grating 2 can also be made thin. As a result, Rayleigh scattering within the optical adjustment layer 3′ caused by the inorganic particles 6 is reduced, whereby a diffractive optical element 22 with even smaller optical losses can be realized.

In the case where a composite material in which inorganic particles are dispersed is used as the second optical material, toughness decreases due to the reduced resin component, which makes cracks likely to occur in the presence of internal stress differences. By adopting the construction of the present embodiment where the optical adjustment layer is shaped so as to have a constant thickness along the normal direction from an envelope passing through the edge of the diffraction grating, thus reducing internal stress differences, it becomes possible to prevent cracks when conducting an environmental test such as a thermal shock

In the diffractive optical elements 21 and 121 of the first and second embodiments above, an antireflection layer may further be provided on the surface of the optical adjustment layer 3, 3′. The antireflection layer may have a single layer structure composed of a film of material having a lower refractive index than that of the optical adjustment layer 3, 3′, or a multilayer structure composed of a film of material having a lower refractive index and a film of material having a higher refractive index than that of the optical adjustment layer 3, 3′. Examples of materials for use in the antireflection layer may include; resins; composite materials of a resin and inorganic particles; thin inorganic films formed by vacuum evaporation, sputtering, CVD technique, or the like; and so on. In the case where a composite material is used as the antireflection layer, it is possible to use silica, alumina, magnesium oxide, or the like, which have a low refractive index, as the inorganic particles.

Moreover, the diffractive optical elements 21 and 121 may have nanostructure antireflection shapes on the surface of the optical adjustment layer 3, 3′. Nanostructure antireflection shapes can be easily formed by a transfer technique (nanoimprinting) using a mold, for example.

Furthermore, the diffractive optical elements 21 and 121 may separately include a surface layer on the surface of the optical adjustment layer 3, 3′ or the antireflection layer, the surface layer acting to adjust dynamic properties such as abrasion resistance and thermal expansion.

### Example

Hereinafter, results of producing diffractive optical elements according to embodiments of the present invention and evaluating their characteristics will be specifically described.

### Example 1

A diffractive optical element having the structure shown in FIG. 2(a) was produced by the following method. The diffractive optical element 21 has a lens action, and is designed so as to utilize 1^{st} order diffracted light. This is also true of any following Example.

First, as the first resin of the first optical material composing the body 1, polycarbonate resin (d line refractive index 1.585, Abbe number 28) was injection-molded, thus producing a body 1 having an annular diffraction grating 2 with a depth of 39 μm on one face, in which the edge of the diffraction grating 2 had an aspherical envelope 4. The effective radius of the lens portion was 1.445 mm; the number of rings was 24; the smallest ring pitch was 30 μm; and the diffraction surface had a paraxial R [radius of curvature] of −1.0144 mm. The focal length of this diffractive optical element is 1.109 mm.

Next, as a raw material of the second resin of the optical adjustment layer 3, an acrylate resin (d line refractive index 1.600, Abbe number 33) was dropped on the body 1 in an amount of 2.8 μL by using a dispenser. A mold (a stainless steel-type alloy surface having a nickel plating film formed thereon; was pressed against the raw material. Ultraviolet irradiation (illuminance; 107 mW/cm²; cumulative light amount; 3000 ml/cm²) was conducted from the rear face (i.e., the face opposite to the face on which the composite material was dropped) of the body 1 to cure the acrylate resin. Thereafter, this was released from the mold, whereby the optical adjustment layer 3 was formed. The optical adjustment layer 3 was formed so as to have a surface configuration with a thickness of 15 μm along the normal direction from an aspherical shape conforming to the envelope shape through the edge of the diffraction grating 2.

In order to evaluate tolerance of thermal stress due to temperature changes, a thermal cycle test was conducted. Specifically, the diffractive optical element 21 was placed in a thermal cycling apparatus (TSE-11-A manufactured by ESPEC CORP.), and 100 cycles of thermal cycling from −40° C. to 85° C. were performed for 30 minutes each.

### Example 2

A diffractive optical element having the structure shown in FIG. 4(a) was produced by the following method.

First, the polycarbonate resin used in Example 1 (d line refractive index 1.585, Abbe number 28) was injection-molded, thus producing a body 1 having an annular diffraction grating 2 with a depth d of 15 μm on one face, in which the edge of the diffraction grating had an aspherical envelope. The effective radius of the lens portion was 1.445 mm; the number of rings was 69; the smallest ring pitch was 16 μm; and the diffraction surface had a paraxial R (radius of curvature) of −1.0144 mm.

Next, a composite material to become the raw material of the optical adjustment layer 3′ was prepared as follows. As the second resin 7, a mixture containing acrylate resin A (d line refractive index 1.529, Abbe number 50) and epoxy acrylate resin D (a line refractive index 1.569, Abbe number 35) at a weight ratio of 3:1 was used. To this mixture, 2-propanoi (IPA) was added as a solvent, and zirconium oxide (d line refractive index 2.10, Abbe number 35) having an effective particle size of 6 nm was dispersed in the mixture so that its weight ratio in the total solid content excluding IPA was 56 weight%.

The optical characteristics of this composite material after drying and curing were as follows: the d line refractive index was 1.623; the Abbe number was 43; and the transmittance of a light beam with a wavelength of 400 to 700 nm was 90% or more (film thickness; 30 μm).

By using a dispenser, 2.4 μL of this composite material was dropped on the body 1, and after being dried with a vacuum drier (25° C.; internal pressure of the vacuum drier: 1300 Pa; 24 hours), it was placed on a mold (a stainless steel-type alloy with a nickel plating film formed on its surface), and from the rear face (the face opposite to the face on which the composite material was dropped) of the body 1, ultraviolet irradiation (illuminance: 107 mW/cm²; cumulative light amount: 9000 mJ/cm²) was performed, thus curing the acrylate resin, and thereafter, it was released from the mold, and formed into the optical adjustment layer 3′. Note that the optical adjustment layer 3′ was formed so as to have a surface configuration with a thickness of 10 nm along the normal direction from an aspherical shape conforming to the envelope shape through the edge of the diffraction grating 2.

A thermal cycle test similar to that of Example 1 was conducted by using this diffractive optical element.

### Comparative Example 1

As a Comparative Example, a diffractive optical element having the same structure as that of Example 2 was produced with a similar method to that of Example 2. A difference from Example 2 is that the optical adjustment layer was made into the same aspherical shape as the envelope through the edge of the diffraction grating.

This diffractive optical element had MTF characteristics similar to the MTE of the diffractive optical element of Example 1. Using this diffractive optical element, a thermal cycle test similar to that of Example 1 was conducted.

Characteristic features and environmental test results of Examples 1 and 2 and Comparative Example 1 are shown in the table below.

TABLE 1

| | | | | | Comparative | |
|---|---|---|---|---|---|---|
| | Example 1 | | Example 2 | | Example 1 | |
| body | polycarbonate | | polycarbonate | | polycarbonate | |
| optical | acrylate | | composite | | composite | |
| adjustment | resin | | material | | material | |
| layer | | | | | | |
| thickness along | 15 | μm | 15 | μm | 5 to 15 | μm |
| normal | (constant) | | (constant) | | (distributed) | |
| direction from | | | | | | |
| envelope | | | | | | |
| through | | | | | | |
| diffraction | | | | | | |
| edge | | | | | | |
| paraxial R of | −1.0144 | mm | −1.0144 | mm | −1.0144 | mm |
| diffraction | | | | | | |
| (radius of | | | | | | |
| curvature) | | | | | | |
| focal length | 1.109 | mm | 1.109 | mm | 1.109 | mm |
| tolerance for | 15 | μm | 15 | μm | 5 | μm |
| eccentricity in | | | | | | |
| perpendicular | | | | | | |
| direction to | | | | | | |
| optical axis | | | | | | |

| | | | |
|---|---|---|---|
| thermal cycle | no cracks | no cracks | some cracks |
| test result | | | |

It can be seen from Table 1 that the paraxial R of diffraction and focal length are all identical between the diffractive optical elements of Examples 1 and 2 and the diffractive optical element of Comparative Example 1, and therefore that the diffractive optical elements of Examples 1 and 2 and the diffractive optical element of Comparative Example 1 have essentially identical optical characteristics. The MTF characteristics of these were measured to be all essentially similar.

On the other hand, in the diffractive optical elements of Examples 1 and 2, the thickness of the optical adjustment layer along the normal direction is invariably 15 μm at any radial position. However, in the diffractive optical element of Comparative Example 1, the thickness of the optical adjustment layer along the normal direction is 15 μm at the central portion, and becomes thinner as the radial position increases, until reaching 5 μm at the periphery.

Due to the respectively optical adjustment layers having such thickness, the tolerance for eccentricity (tolerance) in a direction perpendicular to the optical axis, with respect to the body of the optical adjustment layer, is 15 μm for the diffractive optical elements of Examples 1 and 2, and 5 μm for the diffractive optical element of Comparative Example 1.

In the thermal cycle test, the diffractive optical elements of Examples 1 and 2 showed no cracks, whereas the diffractive optical element of Comparative Example 1 had some cracks.

These results indicate that, with the diffractive optical elements of Examples, it is possible to reduce crack occurrences while suppressing deterioration in optical characteristics, and an increased tolerance can be provided during production.

### INDUSTRIAL APPLICABILITY

A diffractive optical element disclosed herein can be suitably used for various optical systems, and suitably used as a camera lens, a spatial low-pass filter, a polarizing hologram, and the like, for example.

### REFERENCE SIGNS LIST

1, 11 body

2, 12 diffraction grating

3, 3′, 13 optical adjustment layer

4, 14 envelope

5, 15 optical axis

6 inorganic particles

7 second resin

17 dispenser

18 mold

21, 22, 121 diffractive optical element

1. A diffractive optical element comprising:
a body being composed of a first optical material, and having a diffraction grating on a surface thereof; and
an optical adjustment layer being composed of a second optical material, and provided on the body so as to cover the diffraction grating, wherein,
an envelope passing through an edge of the diffraction grating presents a curved an aspherical shape;
along an optical axis direction, an interval between the envelope passing through the edge of the diffraction grating and an envelope passing through grooves of the diffraction grating is constant; and
the optical adjustment layer has a uniform thickness along a normal direction from the envelope passing through the edge of the diffraction grating.

2. The diffractive optical element of claim 1, wherein a surface of the optical adjustment layer presents an aspherical shape different from the aspherical shape presented by the envelope passing through the edge of the diffraction grating.

3. The diffractive optical element of claim 1, wherein the second optical material comprises a resin.

4. The diffractive optical element of claim 3, wherein the second optical material further comprises inorganic particles, the inorganic particles being dispersed within the resin.

5. The diffractive optical element of claim 1, wherein a refractive index of the first optical material is smaller than a refractive index of the second optical material, and a wavelength dispersion of the refractive index of the first optical material is greater than a wavelength dispersion of the refractive index of the second optical material.

6. The diffractive optical element of claim 1, wherein the first optical material comprises another resin.
